(19) United States
(12) Patent Application Publication
(10) Pub. No.: US 2023/0045304 A1
(43) Pub. Date: Feb. 9, 2023

(54) ADJUSTABLE MOUNTS FOR PHALLIC DEVICES

(71) Applicant: Martin Tucker, Tarzana, CA (US)

(72) Inventor: Martin Tucker, Tarzana, CA (US)

(21) Appl. No.: 17/880,628

(22) Filed: Aug. 3, 2022

Related U.S. Application Data
(60) Provisional application No. 63/228,736, filed on Aug. 3, 2021.

(51) Int. Cl. A61H 19/00

(52) U.S. Cl. CPC A61H 19/44; A61H 2201/0153; A61H 2201/1685; A61H 2201/013; A61H 2201/1652

(57) ABSTRACT

A mount apparatus for phallic devices comprising a plate, an attachment mechanism, and openings disposed in plate, wherein sliding mounts are disposed in openings, and wherein sliding mounts comprise connection points.

### CROSS-REFERENCE TO RELATED APPLICATION

This application claims the benefit of U.S. Provisional Patent Application Ser. No. 63/228,736 filed Aug. 3, 2021, titled “MULTI-SPEED VIBRATOR AND ADJUSTABLE MOUNT FOR PHALLIC DEVICES,” and the subject matter thereof is incorporated herein by reference thereto.

### TECHNICAL FIELD

The present invention relates to a sexual stimulation device, and more specifically to adjustable mounts for phallic devices.

### BACKGROUND ART

Sex toys and erotic sexual stimulation devices are abundant in the prior art. Many sexual stimulation devices provide thrusting of a dildo or other phallic device, while some simply provide a placement point for a phallic device and the user moves either themselves or the phallic device as desired. These prior art devices require the phallic device to be attached to a device via a connection point. When the devices provide thrusting, they only provide certain movement of the phallic device, typically only movement that is parallel to the thrusting device.

The prior art devices require the phallic device to be attached to a device via a connection point. There are currently no devices on the market that provide adjustable connection mounts for multiple phallic device that can be attached to a sex machine.

Therefore, there is a need for an adjustable mount for multiple phallic devices that is lightweight, can be used with a large variety of sex machines/toys, and securely holds a phallic device. The prior art invention overcomes the shortcoming contained in the prior art by providing a such a device that provides all of those features.

Certain embodiments of the invention have other steps or elements in addition to or in place of those mentioned above. The steps or element will become apparent to those skilled in the art from a reading of the following detailed description when taken with reference to the accompanying figures.

None of the prior art fully addresses the problems resolved by the present invention. The present invention overcomes these limitations contained in the prior art by providing an adjustable mount apparatus for sexual devices that is sturdy, reliable, easy to use, safe, and inexpensive.

### BRIEF DESCRIPTION OF THE DRAWINGS

FIG. 1 illustrates a perspective view of the adjustable mount apparatus of the present invention with phallic inserts;

FIG. 2 illustrates a perspective view of the adjustable mount apparatus of the present invention disposed on base with suction cups;

FIG. 3 illustrates a perspective view of the adjustable mount apparatus of the present invention disposed on a knuckle handle;

FIG. 4 illustrates a perspective view of (a) the phallic device mount for harness; and (b); and the phallic device suction cup mount;

FIG. 5 illustrates a perspective view of the adjustable mount apparatus of the present invention disposed on an ergonomic handle;

FIG. 6 illustrates four views of the harness apparatus of the present invention, view (a) illustrates a front view of harness apparatus of the present invention in the closed position; (b) illustrates a front view of harness apparatus of the present invention in the open position; (c) illustrates a perspective view of harness apparatus of the present invention with phallic device disposed on same; and (d) illustrates a perspective view of phallic device mount of the present invention; and

FIG. 7 illustrates a perspective view of an alternate embodiment of the adjustable mount of the present invention disposed on a knuckle handle.

### DETAILED DESCRIPTION OF THE INVENTION

The best mode for carrying out the invention will be described herein. The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. To avoid obscuring the present invention, some well-known system configurations, and process steps are not disclosed in detail. The figures illustrating embodiments of the system are semi-diagrammatic and not to scale and, particularly, some of the dimensions are for the clarity of presentation and are shown exaggerated in the drawing figures.

Alternate embodiments have been included throughout, and the order of such are not intended to have any other significance or provide limitations for the present invention.

For expository purposes, the term “horizontal” as used herein is defined as a plane parallel to the plane or surface of the present apparatus, regardless of its orientation. The term “vertical” refers to a direction perpendicular to the horizontal as just defined. Terms, such as “above”, “below”, “bottom”, “top”, “side”, “higher”, “lower”, “upper”, “over”, and “under”, are defined with respect to the horizontal plane, as shown in the figures. The term “on” means that there is direct contact among elements.

The present invention provides adjustable mounts for phallic devices.

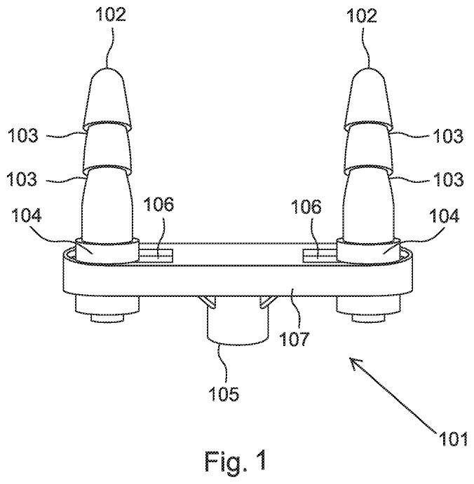

FIG. 1 shows a perspective view of the adjustable mount apparatus 101 of the present invention with phallic inserts 102. Openings 106 are disposed in adjustable mount apparatus plate 107. Sliding mounts 104 are disposed in openings 106. Adjustable mount apparatus connection point 105 is disposed on adjustable mount apparatus plate 107. Adjustable mount apparatus connection point 105 allows adjustable mount apparatus 101 to be attached to devices. Adjustable mount apparatus connection point 105 comprises a female receiver with threading to allow for male attachments with threads to be screwed into adjustable mount apparatus connection point 105. Connection points comprised of threaded male attachments are disposed on sliding mounts 104.

Sliding mounts 104 comprise a connection point that can be used to attach to phallic inserts 102, and other devices. The connection points on the sliding mounts may comprise threaded male receivers.

Sliding mounts 104 can be slid horizontally with respect to the adjustable mount apparatus 101 and secured in place. This allows for universal fit and comfort. Sliding mounts 104 comprise a mechanism to lock them in place in openings 106.

Phallic insert ribs 103 act are disposed on phallic inserts 102 and act to securably attach to a phallic sleeve to hold a phallic sleeve in place. A phallic sleave fits over phallic inserts 102.

Phallic inserts 102 are removable, and additional phallic devices can be disposed directly on sliding mounts 104.

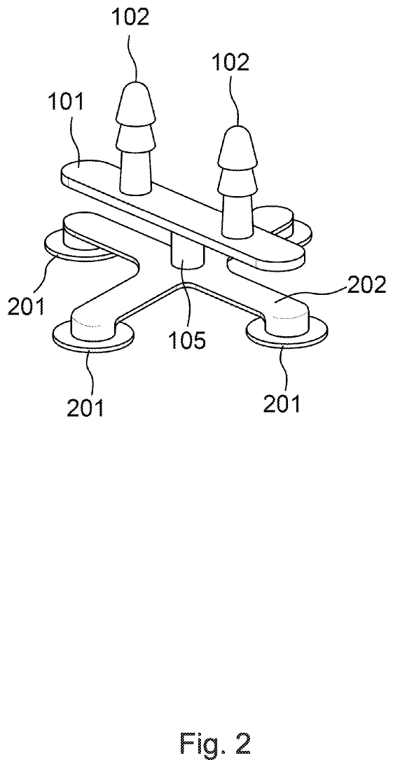

FIG. 2 illustrates a perspective view of the adjustable mount apparatus 101 of the present invention disposed on base 202. Legs of base 202 contain suction cups 201 on the distal ends. Phallic inserts 102 are disposed on adjustable mount apparatus 101 via sliding mounts 104 (not called out on this drawing). Adjustable mount apparatus connection point 105 is connected to base 202.

For simplicity and clarity, openings 106 and sliding mounts 104 are not shown in FIG. 2.

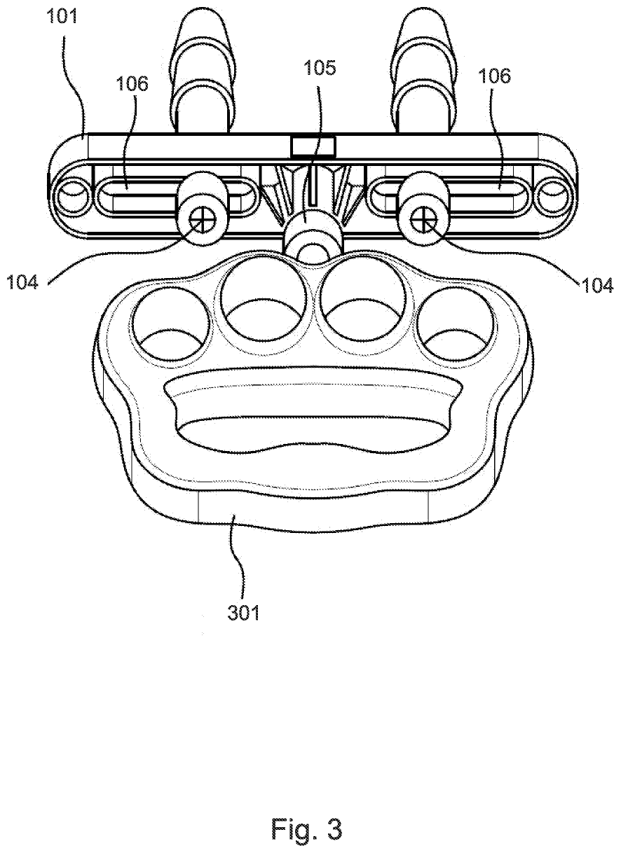

FIG. 3 illustrates a perspective view of the adjustable mount apparatus 101 of the present invention disposed on knuckle handle 301. Adjustable mount apparatus connection point 105 is connected to knuckle handle 601.

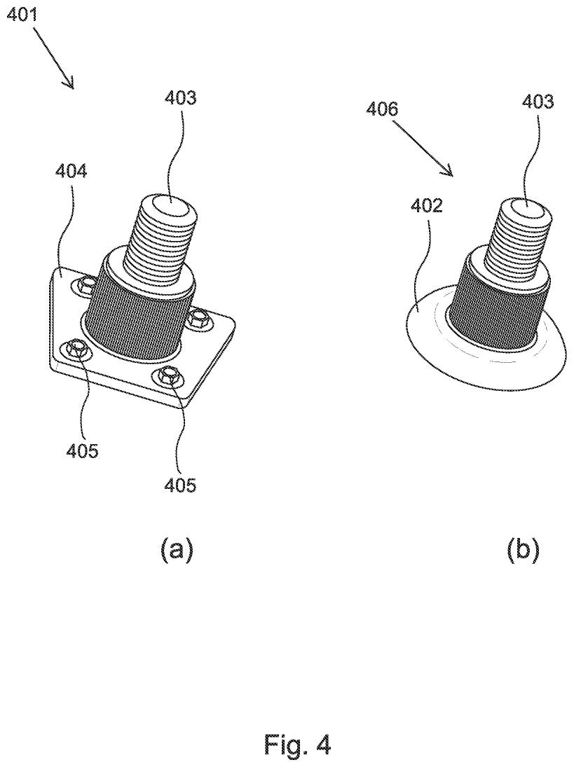

FIG. 4(a) illustrates a perspective view of phallic device mount 401 for use with harnesses. Receiver 403 is disposed on plate 404 and is used to connect to receiving points of phallic devices, or other devices. Plate 404 comprises connection points 405 to attach to harnesses or other devices. Receiver 403 may comprise a threaded male receiver, or other means for attaching to a phallic device, or other devices.

FIG. 4(b) illustrates a perspective view of the phallic device suction cup mount 406. Suction cup 402 is used to attach to surfaces such as walls, floors, etc. Receiver 403 is disposed on suction cup 402. Receiver 403 may comprise a threaded male receiver, or other means for attaching to a phallic device, or other devices.

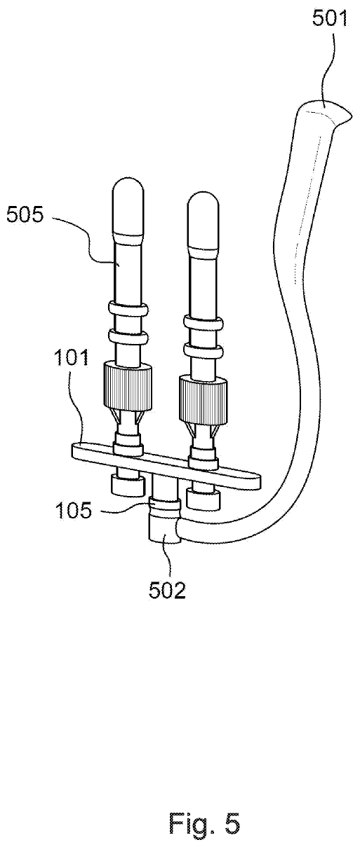

FIG. 5 illustrates a perspective view of the adjustable mount apparatus 101 of the present invention disposed on an ergonomic handle 501. Adjustable mount apparatus connection point 105 is disposed on ergonomic handle connection point 502. Ergonomic handle 501 allows a user to use the adjustable mount apparatus 101 without a partner or other apparatus. Phallic device 505 is disposed on adjustable mount apparatus 101. Phallic device 505 serves the same purpose as phallic inserts 102.

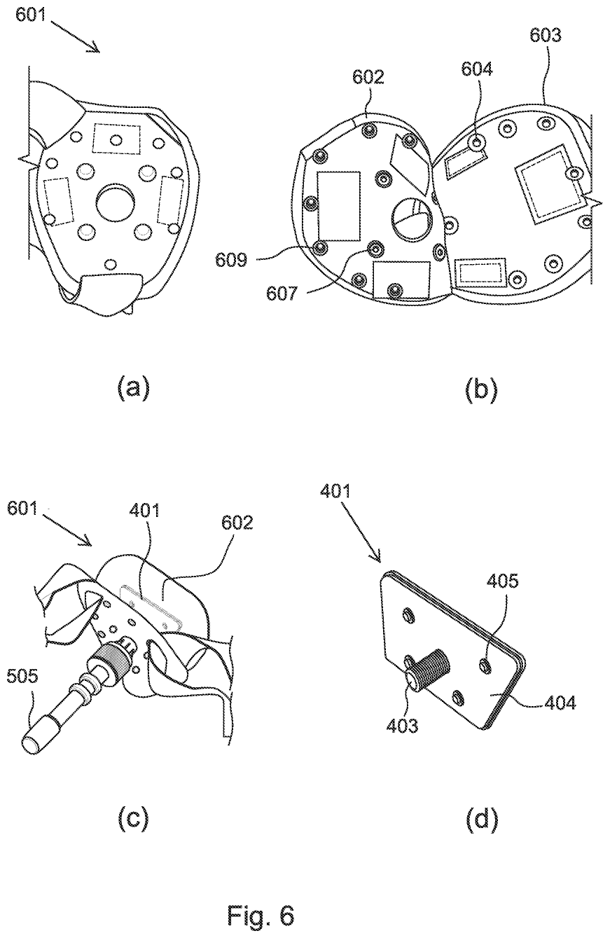

FIG. 6(a) illustrates a front view of harness apparatus 601 of the present invention in the closed position.

FIG. 6(b) illustrates a front view of harness apparatus 601 of the present invention in the open position. Front flap 602 is attachably attached to back plate 603. Front buttons 609 and 607 securely attach to rear buttons 604 to securely close harness apparatus 601. There are a number of front buttons 609 and 607 that are near the edges of front flap 602 that correspond to rear buttons 604. Front flap 602 comprises an opening for a phallic device.

FIG. 6(c) illustrates a perspective view of harness apparatus 601 of the present invention with phallic device 505 disposed on same. Phallic device 505 is securably attached to phallic device mount 401 via receiver 403 (as shown in FIG. 6(d)). Phallic device mount 401 is disposed on back plate 603 and front flap 602. Back plate 603 is securably attached to front flap 602 via front buttons 609 and 607 and rear buttons 604.

FIG. 6(d) illustrates a perspective view of phallic device mount 401 of the present invention. Phallic devices are securably attached to receiver 403. Connection points 405 are disposed on plate 404. Connection points 405 securably attach to front buttons 609 and 607 and/or rear buttons 604. Receiver 403 as shown in FIG. 6 is the same as the receiver 403 as shown in FIG. 4.

Harness apparatus 601 may contain any number of connection points on front flap 602 and back plate 603. Either front flap 602 and back plate 603, or both front flap 602 and back plate 603, may contain connection points to attach securely to connection points 405 of plate 404.

Harness apparatus 601 can be disposed in any number of apparatuses, such as, wearable harnesses.

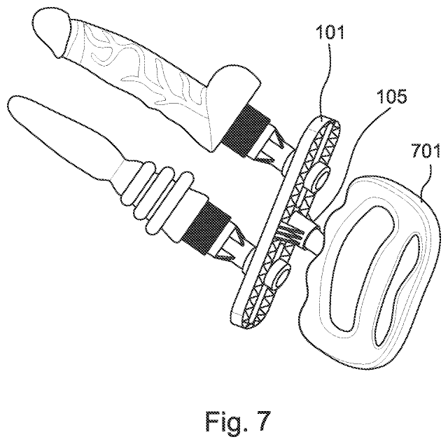

FIG. 7 illustrates a perspective view of an alternate embodiment knuckle handle 701 of the present invention. Phallic inserts are disposed on adjustable mount apparatus 101.

All references male/female receivers or threaded receivers can be substituted with any type of means for securably attaching two parts, as appropriate.

Adjustable mount apparatus connection point 105 and connection points disposed on sliding mounts 104 comprise attachment point receivers that can easily be attached to any connection point, including, but not limited to, prior art thrusting devices, stationary devices such as suction cups, etc. The connection can be any type of connection as desired.

Connection points disposed on sliding mounts 104 (not shown in the figures) comprise any type of attachment point that allows for the attachment of phallic or any other type of devices, as desired.

The phallic sleeves are hollow, enclosed rubber (or other appropriate material) phallic shaped sleeves that fit snugly around phallic inserts 102. Phallic insert ribs 103 act to create suction in order to hold the phallic sleeves in place securely and prevent the phallic sleeves from sliding off of the phallic inserts 102.

Although a phallic device has been shown, any number of sexual toys can be attached and used with the current invention.

In one embodiment of the present invention, phallic inserts 102 are disposed directly on adjustable mount apparatus 101 without sliding mounts 104.

The best mode for carrying out the invention has been described herein. The previous embodiments are described in sufficient detail to enable those skilled in the art to make and use the invention. It is to be understood that other embodiments would be evident based on the present disclosure, and that system, process, or mechanical changes may be made without departing from the scope of the present invention.

In the previous description, numerous specific details and examples are given to provide a thorough understanding of the invention. However, it will be apparent that the invention may be practiced without these specific details and specific examples. While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters previously set forth herein or shown in the accompanying drawings are to be interpreted in an illustrative and non-limiting sense.

What is claimed is:

1. A mount apparatus comprising:
a plate;
an attachment mechanism; and
openings disposed in plate;
wherein sliding mounts are disposed in openings; and
wherein sliding mounts comprise connection points.

2. The device of claim 1, wherein:
the connection points disposed on sliding mounts comprise threaded male receiver.

3. The device of claim 1, wherein:
the attachment mechanism comprises a female receiver.

4. The device of claim 1, wherein:
phallic devices are disposed on the connection points disposed on sliding mounts.

5. The device of claim 1, wherein:
the attachment mechanism comprises a threaded female receiver.

6. The device of claim 1, wherein:
the attachment mechanism is disposed on an ergonomic handle.

7. The device of claim 1, wherein:
the attachment mechanism is disposed on a knuckle handle.

8. A mount apparatus comprising:
a plate;
an attachment mechanism;
phallic inserts; and
openings disposed in plate;
wherein sliding mounts are disposed in openings;
wherein phallic inserts are disposed on sliding mounts; and
wherein sliding mounts comprise connection points.

9. The device of claim 8, wherein:
phallic sleaves are disposed on phallic inserts and held in place by ribs disposed on phallic inserts.

10. The device of claim 8, wherein:
ribs are disposed on the phallic inserts.

11. The device of claim 10, further comprising:
phallic sleeves are disposed on phallic inserts.

12. A mount apparatus comprising:
a plate;
a receiver; and
receiving points;
wherein receiving points are disposed on the plate.

13. The device of claim 12, wherein:
the plate comprises a suction cup.

14. The device of claim 12, wherein;
the receiver comprises a threaded mail receiver.

15. The device of claim 12, wherein:
the mount apparatus is disposed in a harness.

16. The device of claim 12, further comprising:
a harness;
whereas the harness comprises a front flap, a back plate;
whereas the front flap and back plate comprises corresponding connection points; and
whereas the mount apparatus is disposed on the back plate via connection points.
